(19) United States
(12) Patent Application Publication
(10) Pub. No.: US 2019/0088933 A1
(43) Pub. Date: Mar. 21, 2019

(54) METHOD FOR PROCESSING ELECTRODE MATERIALS FOR BATTERIES

(71) Applicant: WACKER CHEMIE AG, Muenchen (DE)

(72) Inventors: Robert MAURER, Muenchen (DE); Rebecca Bernhard, Muenchen (DE); Daniel Braunling, Muenchen (DE); Eckhard Hanelt, Muenchen (DE)

(21) Appl. No.: 16/080,966

(22) PCT Filed: Feb. 27, 2017
(86) PCT No.: PCT/EP2017/054528

§ 371 Date: Aug. 29, 2018

(30) Foreign Application Priority Data
Mar. 1, 2016 (DE) 10 2016 203 352.2

(51) Int. Cl. H01M 4/36; H01M 4/62; H01M 4/38; H01M 4/04; H01M 4/134; H01M 4/1395

(52) U.S. Cl. CPC H01M 4/364; H01M 4/622; H01M 4/1395; H01M 4/0404; H01M 4/134; H01M 4/386

(57) ABSTRACT

The invention relates to methods for processing electrode materials for batteries, characterized in that a) mixtures containing active material particles, one or more binders and one or more dispersion liquids are dried, whereby active material particles in the form of dispersible granulates (active material granulates) are obtained, and b) the active material particles obtained in step a) in the form of dispersible granulates are mixed with one or more solvents.

The invention relates to methods for processing electrode materials for batteries, active material particles in the form of dispersible granules and also the use thereof for producing batteries, in particular lithium ion batteries.

Batteries are electrochemical energy stores which are used, for example, in the field of portable electronics, for tools and also for electrically driven means of transport such as bicycles or automobiles. A distinction is made between primary and secondary cells, with the term rechargeable batteries or accumulators also being used for the latter. At the present time, lithium ion batteries are the most practically useful electrochemical energy stores having the greatest gravimetric and volumetric energy densities.

Electrode materials contain active material particles which can serve as stores for electrical charge by taking up or releasing ions. Graphitic carbon is at present widespread as material for the negative electrode (“anode”) of rechargeable lithium ion batteries. However, a disadvantage is its relatively low electrochemical capacity of theoretically not more than 372 mAh per gram of graphite, which corresponds to only about one tenth of the electrochemical capacity which can be theoretically achieved using lithium metal. For this reason, there has long been a search for alternative materials for anodes, in particular in the field of (semi)metals which alloy with lithium. Silicon has been identified as a suitable candidate here. Silicon forms binary electrochemically active alloys with lithium, which can achieve very high lithium contents and, for example in the case of Li_{4.4}Si, theoretical specific capacities in the region of 4200 mAh per gram of silicon. As regards the size and shape of the silicon particles, teaching is in various directions in the literature. Thus, WO 2014/202529 recommends, in particular, nanosize, unaggregated silicon particles and EP 1730800 recommends nanosize, aggregated silicon particles. Coarse silicon particles having particle diameters of from 1 to 10 μm are described for electrode materials in, for example, US 2003235762.

Milling processes are very common for producing active material particles of suitable size. Dry milling processes and, particularly for producing smaller particles, wet milling processes are employed, as described, for example, in WO-A 14202529. Wet milling results in particles which are dispersed in a liquid medium. However, the products that have dried in such dispersions can be redispersed completely only with difficulty, so that relatively large agglomerates of the primary active material particles are present after redispersion. A similar situation also applies to the particles obtained by dry milling. Very complete dispersion of the active material particles is, however, necessary because electrode coatings that contain agglomerates result in batteries which can suffer damage during charging and discharging to an increasing extent owing to the volume change in the active material particles occurring in such a case, especially in the case of silicon particles. Very complete dispersion of the active material particles is also desirable in order to achieve uniform blending of these particles with the further constituents of the electrode materials and finally achieve conductive and defined bonding of the particles in the electrode.

In practice, pulverulent active material particles are, for this reason too, preferred for producing electrode coatings because the use of different liquid media in wet milling and electrode production is made possible thereby. When mixing liquid preparations containing different solvents, there is additionally the risk that incompatibility, for example coagulation of formulation constituents, will occur. Here, the dry active material may be present entirely in the form of agglomerates composed of a plurality of active material particles as long as the agglomerates can be redispersed and again release small particles. The use of active material particles which are present in solid form opens up greater flexibility in the processing of these to produce electrode materials, for example in the selection of the solids content or liquid constituents of the formulation. In addition, dry preparations are generally more storage-stable and can be handled more simply during transport and also in industrial practice than suspensions having a high solids content.

A further problem associated with powders of nanosize or p-size particles is their tendency to form dust. Dust formation should be avoided wherever possible.

In the light of this background, it was an object of the invention to provide active material particles in the form of dispersible granules for electrode materials of batteries, in particular of lithium ion batteries. Such dispersible granules should be able to be redispersed very completely into their primary particles and be able to be dispersed very uniformly in the electrode materials. In addition, corresponding dispersible granules should if possible have less tendency to form dust than pure active material particles.

This object is surprisingly achieved by mixtures containing active material particles and dispersing liquids being dried in the presence of binders. The dispersible granules obtained in this way can be incorporated into electrode materials for batteries in the desired way and also display reduced dusting behavior.

The drying of silicon particles is known from processes for producing carbon-coated silicon particles. Here, dispersions of silicon particles and specific carbon precursor molecules are dried, subsequently pyrolyzed and only after this chemical modification incorporated into anode materials for lithium ion batteries, as described, for example, in CA 2752844. In CN 103187556, dispersions of silicon particles, polymers and graphite are firstly spray-dried and subsequently pyrolyzed. To produce silicon particles having a specific morphology, US 2014/0162129 recommends spray drying dispersions containing particles of silicon, silicon oxide, metal silicides and carbon or specific polymers as carbon precursor.

DE 691 10438 T2 describes water-redispersible powders of water-insoluble vinyl and/or acrylic polymers which contain silicone as hydrophobicizing additive and are produced, for example, by means of spray drying. Such polymer powders are employed as auxiliaries for hydraulic binders in the building industry.

The invention firstly provides methods for processing electrode materials for batteries, characterized in that

a) mixtures containing active material particles, one or more binders and one or more dispersing liquids are dried to give active material particles in the form of dispersible granules (active material granules) and

b) the active material particles in the form of dispersible granules obtained in step a) are mixed with one or more solvents.

The active material granules obtained by drying in step a) are generally agglomerates of active material particles. As a result of the method of the invention, the active material particles in the agglomerates are generally completely or partly enveloped with binder. Such active material granules are therefore generally significantly larger than the active material particles used as starting materials. The active material particles (primary particles) used for producing the active material granules can be released again by addition of solvent to the active material granules and optionally additional external energy input, in particular mechanical stressing, for example by mechanical stirring or ultrasonic treatment.

For the purposes of the present invention, an electrode material is based on a mixture of a plurality of materials which allows electrochemical energy to be stored in a battery, or to be taken from a battery, by means of oxidation or reduction reactions. The electrode material which in the charged battery supplies energy as a result of an oxidative electrochemical reaction is referred to as anode material or else as negative electrode material.

Preferred binders are polyacrylic acid or alkali metal salts thereof, in particular lithium or sodium salts thereof, polyvinyl alcohols, cellulose or cellulose derivatives, polyalkylene oxides such as polyethylene glycol, polyvinylidene fluoride, polytetrafluoroethylene, polyolefins, polyimides, in particular polyamideimides, or thermoplastic elastomers, in particular ethylene-propylene-diene terpolymers. Particular preference is given to cellulose derivatives, in particular carboxymethyl cellulose. Particularly preferred salts are alkali metal, in particular lithium or sodium, salts thereof.

The mixtures in step a) preferably contain ≤95% by weight, more preferably ≤50% by weight, even more preferably ≤35% by weight, particularly preferably ≤20% by weight, most preferably ≤10% by weight and especially preferably ≤5% by weight, of binder. The mixtures in step a) preferably contain ≥0.05% by weight, particularly preferably ≥0.3% by weight and most preferably ≥1% by weight, of binder. The abovementioned figures in percent by weight are in each case based on the dry weight of the mixtures in step a).

The term dry weight relates generally to the total weight of a composition minus the weight of the dispersing liquid or solvent present therein.

As dispersing liquid, it is possible to use organic and/or inorganic solvents. Mixtures of two or more dispersing liquids can also be used. An example of an inorganic solvent is water. Organic solvents are, for example, hydrocarbons, esters or preferably alcohols. The alcohols preferably contain from 1 to 7 and particularly preferably from 2 to 5 carbon atoms. Examples of alcohols are methanol, ethanol, propanol, butanol and benzyl alcohol. Preference is given to ethanol and 2-propanol. Hydrocarbons preferably contain from 5 to 10 and particularly preferably from 6 to 8 carbon atoms. Hydrocarbons can, for example, be aliphatic or aromatic. Examples of hydrocarbons are toluene and heptane. Esters are generally esters of carboxylic acids and alkyl alcohols, for example ethyl acetate. The dispersing liquid is generally present in liquid form at room temperature and has a viscosity at 20° C. of preferably ≤100 mPas and particularly preferably ≤10 mPas. When silicon is used as active material, the dispersing liquid is preferably inert or weakly reactive towards silicon.

The mixtures in step a) preferably contain ≥10% by weight, more preferably ≥30% by weight, particularly preferably ≥50% by weight and most preferably 80% by weight, of dispersing liquid. The mixtures in step a) preferably contain ≤99.8% by weight, particularly preferably ≤95% by weight and most preferably ≤90% by weight, of dispersing liquid. The abovementioned figures in percent by weight are in each case based on the total weight of the mixtures in step a).

Active material particles for the purposes of the present invention are particles in general which can serve as stores for electric charge by taking up or releasing ions.

Preferred active material particles are based on graphite, silicon, metal oxides or metal phosphates. Examples of metal oxides are oxides or mixed oxides of titanium, tin, cobalt, nickel, aluminum, manganese or iron. Mixed oxides preferably contain nickel, cobalt, aluminum or manganese. An example of a metal phosphate is iron phosphate. Metal phosphates or metal oxides can additionally contain lithium. Particular preference is given to silicon. Active material particles comprising silicon are most preferred.

The active material particles preferably have particular bulk material properties. Bulk material properties are described, for example in the international standard FEM 2.581 of the “Federation Europeenne de la Manutention”. In the standard FEM 2.582, the general and specific bulk material properties are defined in terms of classification. Characteristic properties which describe the consistency and the state of the material are, for example, particle shape and particle size distribution (FEM 2.581/FEM 2.582: General characteristics of bulk products with regard to their classification and their symbolization).

According to DIN ISO 3435, bulk materials can be classified into six different particle shapes as a function of the nature of the particle edges:
I: sharp edges with approximately equal extensions in the three dimensions (for example: cube);
II: sharp edges of which one is significantly longer than the other two (for example: prism, blade);
III: sharp edges of which one is significantly smaller than the other two (for example: plate, flakes);
IV: round edges with approximately equal extensions in the three dimensions (e.g.: sphere);
V: round edges, significantly greater in one direction than in the other two (for example: cylinder, rod);
VI: fibrous, thread-like, lock-like, tangled.

The active material particles used in step a) preferably have particle shapes I to VI, more preferably I, II, III or IV and particularly preferably I or IV in accordance with DIN ISO 3435.

As active material particles, preference is given to silicon particles. Silicon particles can consist of elemental silicon, a silicon oxide or a binary, ternary or multinary silicon-metal alloy (with, for example, Li, Na, K, Sn, Ca, Co, Ni, Cu, Cr, Ti, Al, Fe). Elemental silicon is preferably used, especially since it has an advantageously high storage capacity for lithium ions.

In general, elemental silicon is understood to mean high-purity polysilicon having a small proportion of foreign atoms (for example B, P, As), silicon deliberately doped with foreign atoms (for example B, P, As), or else silicon from metallurgical processing, which can have elemental contamination (for example Fe, Al, Ca, Cu, Zr, C).

If the silicon particles contain a silicon oxide, then the stoichiometry of the oxide SiO. is preferably in the range 0<x<1.3. If the silicon particles contain a silicon oxide having a higher stoichiometry, then the layer thickness of this on the surface is preferably less than 10 nm.

If the silicon particles are alloyed with an alkali metal M, then the stoichiometry of the alloy M_{y}Si is preferably in the range 0<y<5. The silicon particles can optionally be prelithiated. In the case of the silicon particles being alloyed with lithium, the stoichiometry of the alloy Li_{z}Si is preferably in the range 0<z <2.2.

Particular preference is given to silicon particles containing ≥80 mol % of silicon and/or 20 mol % of foreign atoms, very particularly preferably 10 mol % of foreign atoms.

The surface of the silicon particles can optionally be covered by an oxide layer or other inorganic and organic groups. Particularly preferred silicon particles bear Si—OH or Si—H groups or covalently bound organic groups, for example alcohols or alkenes, on the surface. The surface tension of the silicon particles, for example, can be controlled by the organic groups. This can thus be matched to the solvents or binders which are used in the production of the granules or in the production of the electrode coatings.

The silicon particles of the mixture in step a) have, before drying, volume-based particle size distributions having medians of the diameter d₅₀ of preferably from 0.03 to 100.0 μm, more preferably from 0.05 to 20.0 μm, particularly preferably from 0.1 to 10.0 μm and most preferably from 0.15 to 7.0 μm.

The volume-based particle size distribution can be determined by static laser light scattering using the Fraunhofer model or the Mie model by means of the Horiba LA 950 measuring instrument using ethanol or isopropanol as dispersing medium for the silicon particles.

The silicon particles are preferably not agglomerated, in particular not aggregated.

Aggregated means that spherical or very largely spherical primary particles, as are, for example, initially formed in gas phase processes for producing silicon particles, grow together during the further course of the reaction of the gas phase process and in this way form aggregates. These aggregates can form agglomerates in the further course of the reaction. Agglomerates are an assembly of primary particles or aggregates without covalent chemical bonds. Agglomerates can in some cases be broken up into the aggregates again by means of kneading and dispersing processes, but this is frequently not possible. Aggregates cannot be or can only partially be broken up into the primary particles by these methods. The presence of silicon particles in the form of aggregates or agglomerates can be made visible by means of, for example, conventional scanning electron microscopy (SEM). Static light scattering methods for determining the particle size distributions, on the other hand, cannot distinguish between aggregates or agglomerates.

The silicon particles have a sphericity of preferably 0.3≤ψ≤1, particularly preferably 0.4ψ≤1 and most preferably 0.5≤ψ1. The sphericity ψ is the ratio of the surface area of a sphere of the same volume to the actual surface area of a body (as defined by Wadell). Sphericities can, for example, be determined from conventional SEM images.

The mixtures in step a) preferably contain ≥5% by weight, more preferably ≥50% by weight, even more preferably ≥65% by weight, particularly preferably ≥80% by weight, most preferably ≥90% by weight and especially preferably ≥95% by weight, of active material particles. The mixtures in step a) preferably contain ≤99.95% by weight, particularly preferably ≤99.7% by weight and most preferably ≤99% by weight, of active material particles. The abovementioned figures in percent by weight are in each case based on the dry weight of the mixtures in step a).

The silicon particles can be produced, for example, by means of gas phase deposition or preferably by milling processes.

Dry milling processes or wet milling processes are possible as milling processes. Here, preference is given to using jet mills, e.g. opposed-jet mills, or impact mills, planetary ball mills or stirred ball mills. The jet mills preferably have an integrated air classifier, which can be static or dynamic, or are operated with circulation through an external air classifier.

Wet milling is generally carried out in a suspension containing organic or inorganic dispersing media. Preferred dispersing media are the dispersing liquids described above.

Wet milling is preferably carried out using milling media whose average diameter is from 10 to 1000 times the 90% percentile d₉₀ of the diameter of the material to be milled, based on the volume distribution of the particle size. Particular preference is given to milling media whose average diameter is from 20 to 200 times the d90 of the starting distribution of the material being milled.

The mixtures in step a) and/or preferably in step b) can additionally contain one or more electrically conductive components and/or one or more additives. Additional amounts of binder can optionally be added in step b).

Examples of electrically conductive components are graphite particles, conductive carbon black, carbon nanotubes or metallic particles, for example copper particles. In the interest of clarity, it may be stated that the electrically conductive components do not comprise any active material according to the invention, in particular not any silicon.

The electrically conductive components preferably have structures of ≤1 μm. The graphite particles preferably have a volume-based particle size distribution between the diameter percentiles d₁₀>0.2 μm and d₉₀<200 μm. Natural or synthetic graphite can be used. The primary particles of conductive carbon black preferably have a volume-based particle size distribution between the diameter percentiles d₁₀=5 nm and d₉₀=200 nm. The primary particles of conductive carbon black can also be branched in a chain-like manner and form up to pm-size aggregates. Carbon nanotubes preferably have diameters of from 0.4 to 200 nm, particularly preferably from 2 to 100 nm and most preferably from 5 to 30 nm. The metallic particles have a volume-based particle size distribution which is preferably between the diameter percentiles d₁₀=5 nm and d₉₀=5 μm and particularly preferably between the diameter percentiles d₁₀=10 nm and d₉₀=800 nm.

The mixtures in step a) preferably do not contain any electrically conductive components, in particular not any graphite.

Examples of additives are pore formers, leveling agents, dopants or materials which improve the electrochemical stability of the electrode in the battery.

The mixtures in step a) preferably contain from 0 to 30% by weight, particularly preferably from 0.01 to 15% by weight and most preferably from 0.1 to 5% by weight, of additives, based on the dry weight of the mixtures in step a). In a preferred, alternative embodiment, the mixtures in step a) do not contain any additives.

The active material granules obtained in step a) have an average volume which is preferably at least ten times and particularly preferably at least 50 times the average volume of the primary particles of the active material particles used in step a).

The average volume of the active material granules is preferably less than 100 mm³. This is advantageous for the handlability of the granules as bulk material.

The average volume of the particles and granules is calculated from the equivalent sphere volume for the median of the particle diameter measured using static laser light scattering, based on the respective volume distribution of the particle sizes.

The size of the active material granules can be influenced by the drying process in step a). The granules from step a) can also be comminuted by conventional methods of mechanical process technology. Preference is given to methods in which only a small proportion of fines is produced. The precise meterability of the granules in the production of electrode inks for battery electrodes, for example, can be influenced via the particle size of the granules.

The active material granules obtained in step a) preferably have the particle shapes I, II, III or IV, particularly preferably the particle shapes I or IV and very particularly preferably the particle shape IV in accordance with DIN ISO 3435.

The active material granules obtained in step a) are generally not coated with carbon, particularly when the active material contains silicon.

The invention further provides active material particles in the form of dispersible granules consisting of silicon particles, one or more binders selected from the group consisting of polyacrylic acid or salts thereof, polyvinyl alcohols, cellulose or cellulose derivatives, polyalkylene oxides, polyvinylidene fluoride, polytetrafluoroethylene, polyolefins, polyimides and ethylene-propylene-diene terpolymers and optionally one or more additives.

The further embodiments of these compositions and amounts of the constituents used in these compositions correspond to what has been said above for step a) according to the invention.

The production of the mixtures for step a) can be carried out by mixing the individual constituents of the mixtures and is not tied to a particular procedure. Mixing can be carried out in conventional mixing apparatuses, for example in rotor-stator machines, high-energy mills, planetary kneaders, stirred ball mills, shaking tables, high-speed mixers, roller mixers or ultrasonic instruments. For example, suspensions containing active material particles can be mixed with binders and optionally additional dispersing liquid. Binders are preferably dissolved or dispersed in a dispersing liquid and subsequently added to a suspension containing active material particles. As an alternative, binders, optionally dissolved or dispersed in dispersing liquid, can be added to a suspension containing active material particles before, during or after milling, in particular wet milling.

Drying in step a) according to the invention can, for example, be carried out by means of fluidized-bed drying, freeze drying, thermal drying, drying under reduced pressure or preferably by means of spray drying. The plants and conditions customary for this purpose can be employed.

Drying can be carried out in ambient air, synthetic air, oxygen or preferably in an inert gas atmosphere, for example in a nitrogen or argon atmosphere. In general, drying is carried out at atmospheric pressure or under reduced pressure. Drying is generally carried out at temperatures of ≤400° C., preferably ≤200° C. and particularly preferably ≤150° C. and in a preferred embodiment at temperatures of from −50° C. to 200° C.

Freeze drying is generally carried out at temperatures below the freezing point of the mixture to be dried, preferably at temperatures in the range from −120° C. to 0° C. and particularly preferably from −20° C. to −60° C. The pressure is preferably in the range from 0.005 to 0.1 mbar.

Drying under reduced pressure is preferably carried out at temperatures of from 40° C. to 100° C. and pressures of from 1 to 10⁻³ mbar.

Spray drying can, for example, be carried out in a spray-drying plant in which atomization is effected by means of single-fluid, two-fluid or multi-fluid nozzles or by means of a rotating disk. The entry temperature of the mixture to be dried into the spray-drying plant is preferably greater than or equal to the boiling point of the mixture to be dried and particularly preferably ≥10° C. higher than the boiling point of the mixture to be dried. For example, the entry temperature is preferably from 80° C. to 200° C., particularly preferably from 100° C. to 150° C. The exit temperature is preferably ≥30° C., particularly preferably ≥40° C. and most preferably ≥50° C. In general, the exit temperature is in the range from 30° C. to 100° C., preferably from 45° C. to 90° C. The pressure in the spray-drying plant is preferably ambient pressure. In the spray-drying plant, the sprayed mixtures have primary droplet sizes of preferably from 1 to 1000 μm, particularly preferably from 2 to 600 μm and most preferably from 5 to 300 μm. The size of the primary particles, the residual moisture content of the product and the yield of the product can be set in a manner known per se via the settings of the inlet temperature, the gas flow (flow) and the pumping rate (feed), the choice of the nozzle, of the aspirator, the choice of the dispersing liquid or of the solids concentration of the spray suspension. For example, relatively high solids concentrations of the spray suspension give primary particles having relatively large particle sizes, while a relatively high spray gas flow (flow) leads to smaller particle sizes.

In the other drying processes, drying is preferably carried out at temperatures of from 0° C. to 200° C., particularly preferably from 10° C. to 180° C. and most preferably from 30° C. to 150° C. The pressure in the other drying processes is preferably from 0.5 to 1.5 bar. Drying can, for example, be effected by contact with hot surfaces, convection or radiative heat. Preferred dryers for the other drying processes are fluidized-bed dryers, screw dryers, paddle dryers and extruders.

The active material granules obtained in step a) are generally used directly in step b) according to the invention. The active material granules obtained in step a) are preferably not subjected to any reaction, in particular not any pyrolysis or carbonization, before step b) is carried out.

In general, the volume-based particle size distributions of the dispersed active material particles obtained in step b) correspond essentially to the particle size distributions of the active material particles used in step a) before drying.

The dispersed active material particles obtained in step b) have volume-based particle size distributions having medians of the diameter d₅₀ of preferably from 0.03 to 100.0 μm, more preferably from 0.05 to 20.0 μm, particularly preferably from 0.1 to 10.0 μm and most preferably from 0.15 to 7.0 μm.

As electrically conductive component for step b), preference is given to graphite, optionally in combination with one or more further electrically conductive components. The proportion of the electrically conductive components in step b) is preferably from 0 to 80% by weight, particularly preferably from 1 to 50% by weight and most preferably from 2 to 30% by weight, based on the dry weight of the compositions in step b).

Further binders can optionally be added in step b). Here, it is possible to use the abovementioned binders. The proportion of binder in step b) is preferably from 0.5 to 25% by weight and particularly preferably from 1 to 20% by weight, based on the dry weight of the compositions in step b).

The proportion of additives in step b) is preferably from 0 to 60% by weight, particularly preferably from 0 to 5% by weight, based on the total weight of the compositions in step b).

As solvents in step b), it is possible to use the dispersing liquids mentioned for step a). Further examples of solvents are ethers such as tetrahydrofuran, pyrrolidones such as N-methylpyrrolidone or N-ethylpyrrolidone, acetone, dimethyl sulfoxide or dimethylacetamide. Preferred solvents are water, hydrocarbons such as hexane or toluene, tetrahydrofuran, pyrrolidones such as N-methylpyrrolidone or N-ethylpyrrolidone, acetone, ethyl acetate, dimethyl sulfoxide, dimethylacetamide or ethanol.

Mixing of the individual components in step b) is not tied to any particular procedure and can be carried out in conventional mixing apparatuses, for example rotor-stator machines, high-energy mills, planetary kneaders, stirred bore mills, shaking tables or ultrasonic instruments. The dispersing in step b) is generally assisted by external energy input, in particular mechanical stressing of the granules. Preferably, the active material granules obtained in step a) are, in step b), firstly dispersed in one or more solvents and subsequently mixed with any further components. The further components can be used as a mixture. Binders additionally added in step b) are preferably used in the form of a solution or dispersion in one or more solvents.

The invention further provides methods for producing electrodes for batteries, in particular for lithium ion batteries, characterized in that the mixtures produced in step b) are applied to an electrically conductive substrate and subsequently dried.

The dispersed active material particles from step b) preferably have volume-based particle size distributions having a 90% percentile of the diameter d90 which is smaller than the thickness of a dry coating produced using the electrode material according to the invention. The d90 is particularly preferably less than 50% of the thickness of the coating and d90 is particularly preferably less than 20% of the thickness of the coating. This measure is helpful for virtually excluding oversize.

The invention further provides for the use of the electrode materials produced according to the invention for the production of batteries, in particular lithium ion batteries.

A battery generally comprises a first electrode as cathode, a second electrode as anode, a membrane as separator arranged between the two electrodes, two connections on the electrodes, a housing accommodating the specified parts and also an electrolyte with which the separator and the two electrodes are impregnated.

In the case of a lithium ion battery, an electrolyte which generally contains lithium ions is used. Electrodes which have been produced according to the invention and contain silicon particles as active material particles are particularly preferably used as negative electrode or anode.

The battery according to the invention can be produced in all customary forms, for example in rolled, folded or stacked form.

The production of corresponding batteries using the electrode materials produced according to the invention can, for example, be carried out as described in WO 2014/202529.

Storage-stable active material granules which can be efficiently dispersed in solvents are advantageously obtainable by the procedure according to the invention. Use of such granules makes it possible to keep the proportions of solvent in the processing of electrode inks relatively low, which is advantageous for the quality of the electrodes. Small particles are converted into larger granules by the drying in the presence of binders. The granules according to the invention tend to form no dust or only little dust during handling. Particularly when using nanosize active material primary particles, the safety problems of dust formation are overcome thereby. For this reason, the additional safety measures necessary for working with small particles can be dispensed with and the processing of these can be simplified.

The particle size distributions of the particles redispersed in step b) and of the particles (primary particles) used for drying in step a) largely correspond. Thus, the occurrence of agglomerates in the mixtures used for electrode production can be at least largely avoided when using the procedure according to the invention, and, surprisingly, no additional oversize is produced. In the lithium ion batteries produced according to the invention, this contributes to the active material particles, in particular the silicon particles, being efficiently conductively bound. The life of lithium ion batteries can also be increased by the avoidance of agglomerate formation. During charging and discharging of the lithium ion batteries, the silicon particles experience a volume change which can, particularly when relatively large silicon agglomerates are present, lead to damage to the anode layer. Such damage can be countered by avoidance of agglomerates. The activity of the lithium ion batteries is surprisingly not impaired by the drying according to the invention of the silicon particles.

The following examples serve to illustrate the invention.

Eight examples of electrode materials were produced using active material particles composed of silicon of differing sizes in combination with different proportions of binders and employing different drying methods (see Table 1). Examples B.2 to B.6 are according to the invention; examples V.1, V.7 and V.8 serve for comparison.

TABLE 1

| | | | | | Particle | |
|---|---|---|---|---|---|---|
| | | | | | size after | |
| | Initial | | | | redispersion ^{c)} | |
| | particle | Use of | Method of | Size of the | d₅₀ | d₉₀ |
| | size ^{a)} | NaCMC ^{d)} | drying | Si granules ^{b)} | [μm] | [μm] |
| V.1 | d₅₀ = | − | Freeze | 0.1-5 mm | 0.98 | 2.79 |
| B.2 | 0.81 μm | + | drying | | 0.83 | 2.09 |
| B.3 | d₉₀ = | + | Vacuum | | 0.81 | 1.82 |
| | 1.94 μm | | drying | | | |
| B.4 | | + | Spray | 2 to 15 μm | 0.82 | 1.89 |
| B.5 | d₅₀ = | + | drying | | 0.19 | 0.39 |
| B.6 | 0.18 μm | ++ | | | 0.19 | 0.33 |
| V.7 | d₉₀ = | − | | No formation | Not | |
| | 0.33 μm | | | of granules | applicable | |
| V.8 | | − | Freeze | 0.1-5 mm | 0.37 | 3.87 |
| | | | drying | | | |

^{a)} Median d₅₀ and 90% percentile d₉₀ of the volume-based particle size distributions of the silicon particles before drying determined by means of static laser light scattering on the Horiba LA 950 in a suspension diluted with ethanol.
^{b)} Particle size range of the dried silicon granules determined by means of optical microscopy and SEM.
^{c)} Median d₅₀ and 90% percentile d₉₀ of the volume-based particle size distributions of the silicon particles after redispersion, determined by means of the abovementioned static laser light scattering.
^{d)} Amount of sodium carboxymethyl cellulose NaCMC used: − without NaCMC; +: NaCMC:Si = 0.5:20 parts by weight; ++: NaCMC:Si = 8:20 parts by weight.

Production of the Silicon Granules in Step a):

In examples B.2 to B.4 according to the invention, 171 g of a 1.4% strength aqueous solution of sodium carboxymethyl cellulose (NaCMC) were in each case initially charged at 25° C. and diluted with 221 g of distilled water while stirring. Subsequently, 329 g of a 29% dispersion of silicon particles in ethanol produced by wet milling and having particle sizes as indicated in Table 1 were in each case added while stirring by means of a high-speed mixer.

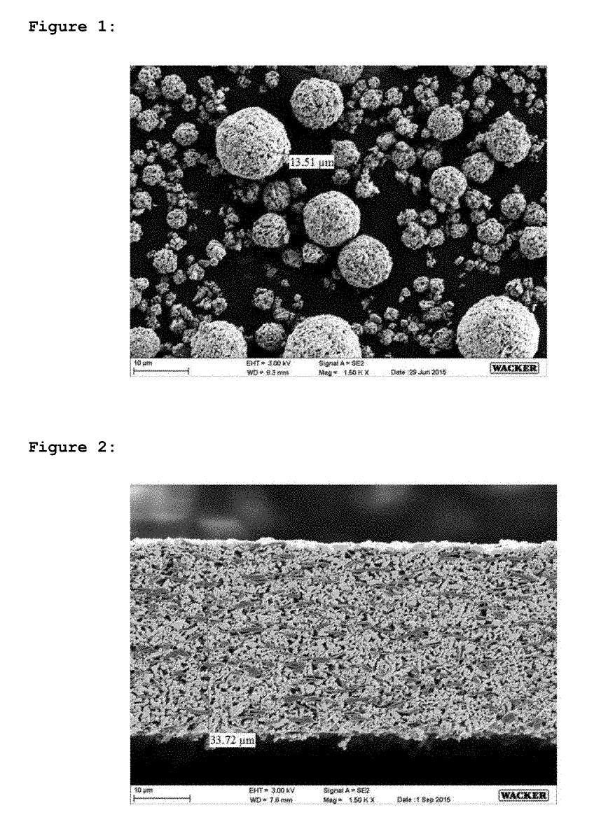

In example B.5 according to the invention, 35 g of a 1.4% strength aqueous solution of NaCMC were initially charged at 25° C. and diluted with 32 g of distilled water while stirring. Subsequently, 86 g of a 23% strength dispersion of silicon particles in ethanol produced by wet milling and having particle sizes as indicated in table 1 were added while stirring by means of a high-speed mixer. The proportion by weight of the polymer NaCMC was thus in each case about 2.5% by weight, based on the dry weight of silicon+NaCMC. In example B.6 according to the invention, 57 g of a 1.4% strength aqueous solution of sodium carboxymethyl cellulose (NaCMC) were initially charged at 25° C. and diluted with 66 g of distilled water while stirring. Subsequently, 9 g of a 22% strength dispersion of silicon particles in ethanol produced by wet milling and having particle sizes as indicated in table 1 were added while stirring by means of a high-speed mixer. The proportion by weight of the polymer NaCMC was thus about 29% by weight, based on the dry weight of silicon+NaCMC. The homogeneous dispersions obtained in this way were converted as reported in table 1 into silicon granules using the drying methods described below. In the case of freeze drying and vacuum drying, the products were obtained in the form of clods which were subsequently broken up roughly to 0.1-5 mm in a mortar. In the case of spray drying, the products were present as spherical granules having diameters in the range from 2 to 15 μm. The proportion of fines in the products of drying according to the invention as per examples B.2 to B.6 was small. FIG. 1 shows, by way of example, an SEM image of the spray-dried silicon granules obtained in B.4 using 2.5% by weight of NaCMC.

Comparative examples V.1, V.7 and V.8 were carried out in a manner analogous to the abovementioned example B.2 according to the measures in table 1, but the corresponding amount of water (in each case 171 g+221 g) was added instead of the addition of the sodium carboxymethyl cellulose solution.

The following three methods were used for drying:

1. Spray Drying of the Silicon Particle Dispersions

A spray dryer having a two-fluid nozzle (BUchi dryer B-290 with inert loop, nozzle 150) was used. The spray dryer was flushed with ethanol. The dispersions containing silicon particles were then introduced and dried under a nitrogen atmosphere at atmospheric pressure. The following settings were selected on the apparatus: inlet temperature 120° C., outlet temperature from 50° C. to 60° C. Atomization component in the closed circuit was nitrogen having a gas flow (flow) of 601 1/h, aspirator: 100%, pump rate (feed): 30%. The dried silicon granules were precipitated by means of a cyclone.

2. Freeze Drying of the Silicon Particle Dispersions

The silicon particle dispersions were introduced into Greiner tubes, frozen at ambient pressure by means of liquid nitrogen and lyophilized at a pressure in the range from 0.005 to 0.01 mbar for two days in a freeze dryer (model Alpha 2-4LD Plus from Martin Christ).

3. Thermal Drying of the Silicon Particle Dispersions Under Reduced Pressure (Vacuum Drying)

The silicon particle dispersions were dried in a Schlenk flask in a vacuum of 3.5*10⁻² mbar at 50° C. while stirring until dry granules were obtained.

Redispersion of the Silicon Particles in Step b):

200 mg of the silicon granules from the examples in table 1 were in each case weighed into 9 ml of water and treated for 30 minutes by means of an ultrasonic instrument (Hielscher UIP250, Sonotrode LS2405) at 50% power and cycle parameter 0.5. This comparatively high mechanical stressing was selected in order to disperse the particles very completely.

The particle size distributions in the suspension were then determined by means of static laser light scattering using the measuring instrument Horiba LA950. Water was used as dispersing liquid for the measurements because the particles were mixed into inks using water as solvent for the electrode production described below. The instrument itself indicates the optimal dilution of the suspensions for the measurement.

Production of Electrode Coatings:

3.83 g of silicon granules from examples B.2 to B.4 and V.1 were in each case placed together with 19.53 g of a 1.4% strength aqueous solution of sodium carboxymethyl cellulose in a beaker at 25° C. and homogenized by means of a high-speed mixer having a 20 mm mixer disk (Dispermat LC30 from VMA-Getzmann) at 4500 revolutions per minute for 5 minutes and subsequently for 30 minutes at 17000 rpm.

1.37 g of graphite were subsequently mixed in while stirring with a Speedmixer (SpeedMixer DAC 150 SP, from Hauschild) at 3500 rpm. The mixtures obtained in this way were homogenized by means of the high-speed mixer for 5 minutes at 4500 rpm and 30 minutes at 12000 rpm. The mixtures were then degassed in the Speedmixer for 5 minutes at 3500 rpm.

To produce electrode coatings using the silicon granules from examples B.5, B.6 and V.8, 0.5 g of the respective granules was placed together with 14.3 g a 1.4% strength aqueous solution of NaCMC and 0.3 g of conductive carbon black Super P in a beaker at 25° C. and homogenized by means of the high-speed mixer using a 20 mm mixer disk at 4500 revolutions per minute for 5 minutes and subsequently for 30 minutes at 17000 revolutions per minute.

1.5 g of graphite were subsequently mixed in while stirring by means of the Speedmixer at 3500 revolutions per minute and homogenized and subsequently degassed as described above.

The paste-like electrode materials obtained in this way were applied by means of a film drawing frame having a gap height of 0.10 mm (Erichsen, model 360) to a copper foil having a thickness of 0.030 mm (Schlenk Metallfolien, SE-Cu58). These electrode coatings were then dried for 60 minutes at 80° C. and ambient pressure in a drying oven.

FIGS. 2 to 5 show, by way of example, ion beam sections through the dried electrode coatings, which were recorded using a scanning electron microscope:

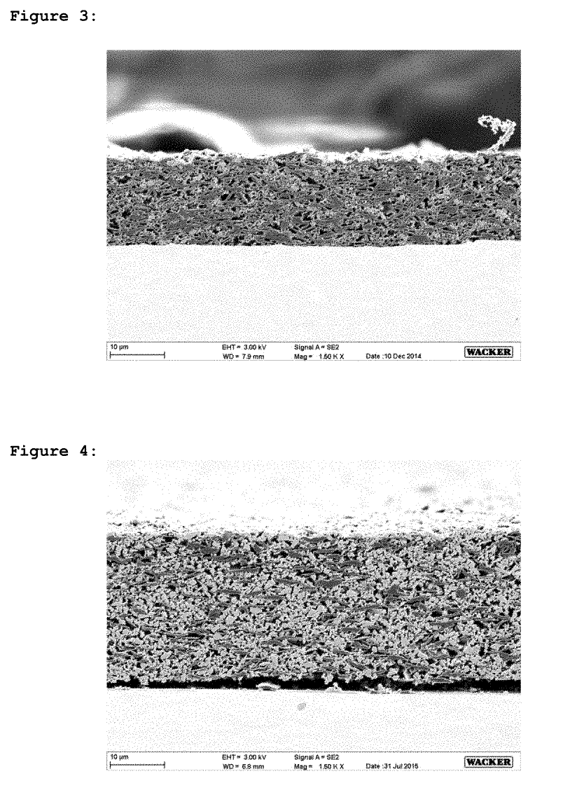

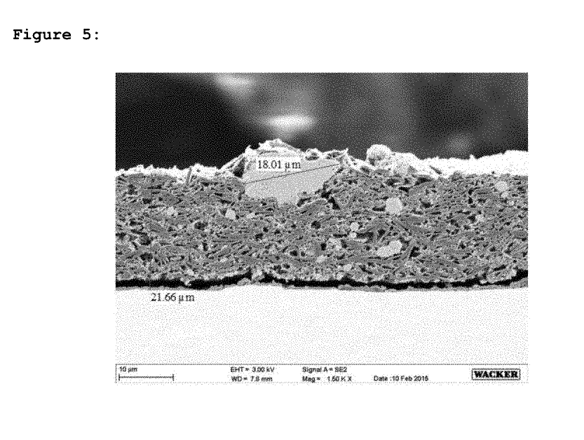

With example B.4: FIG. 2; with example B.6: FIG. 3; example B.2: FIG. 4 and comparative example V.8: FIG. 5.

The silicon particles (light grey) and the graphite particles (dark grey) are, with the exception of the comparative examples, distributed uniformly in the coatings. The originally spherical granules produced using NaCMC, as shown in FIG. 1, have broken up; only the products produced without NaCMC are to be seen as relatively coarse lumps in the electrode coatings (see FIG. 5).

Discussion of the Examples:

In examples B.2 to B.6 according to the invention, the particle sizes after redispersion are virtually identical to the starting particles (table 1). The 90% percentiles d₉₀ of the starting particles determined by means of static laser light scattering are approximately twice the medians d₅₀ of the volume-based particle size distributions of the silicon particles. This also applies regardless of the drying method to all redispersed granules containing NaCMC, but not to comparative examples V.1 and V.8. The significantly higher d90 values here show that the particles in the comparative examples cannot be completely redispersed despite the high mechanical stress.

This difference is even more prominent when the granules have been subjected to less stress during redispersion. In the case of example B.4, the particle size distribution determined by static laser light scattering was virtually unchanged at d₉₀=2.5 μm after treatment with ultrasound for only 10 minutes, while in the case of comparative example V.1 a bimodal distribution having a significantly higher d₉₀ of 11.6 μm was found.

The silicon granules containing NaCMC of examples B.2 to B.6 gave homogeneous electrode coatings free of agglomerates for all drying methods, as shown in FIGS. 2 to 4, even though the mechanical stress on the particles in the production of the electrode material was significantly lower than in the redispersion for measurement of the particle size distributions in table 1.

However, the products produced by freeze drying without NaCMC as per comparative examples V.1 and V.8 led under the same conditions to electrode coatings having inclusions of coarse agglomerates, which can be seen as large bright spots in FIG. 5.

When an attempt was made to carry out spray drying without use of a binder in comparative example V.7, no product was able to be precipitated in the cyclone of the spray dryer. No silicon granules according to the invention were formed and for this reason no further experiments on producing electrode coatings were carried out.

1. A method for processing electrode materials for batteries, comprising:
a) drying mixtures including active material particles comprising silicon particles, one or more binders and one or more dispersing liquids to produce active material particles in the form of dispersible granules, with the proviso that the active material particles in the form of dispersible granules obtained in step a) are not coated with carbon, and
b) mixing the active material particles in the form of dispersible granules obtained in step a) with one or more solvents, wherein the active material particles which were used for producing the active material particles in the form of dispersible granules are released again.

2. The method for processing electrode materials for batteries as claimed in claim 1, wherein the activated material particles in the form of dispersible granules obtained by drying in step a) are agglomerates of active material particles which are completely or partly enveloped with the one or more binders.

3. (canceled)

4. The method for processing electrode materials for batteries as claimed in claim 1, wherein the active material particles of the mixtures in step a) have, before drying, volume-based particle size distributions having medians of the diameter d₅₀ of from 0.03 to 100.0 μm.

5. The method for processing electrode materials for batteries as claimed in claim 1, wherein the dispersed active material particles obtained in step b) have volume-based particle size distributions having medians of the diameter d₅₀ of from 0.03 to 100.0 μm.

6. The method for processing electrode materials for batteries as claimed in claim 1, characterized in that one or more binders are selected from the group consisting of polyacrylic acid or alkali metal salts thereof, polyvinyl alcohols, cellulose or cellulose derivatives, polyalkylene oxides, polyvinylidene fluoride, polytetrafluoroethylene, polyolefms, polyimides and ethylene-propylene-diene terpolymers.

7. (canceled)

8. A method for producing electrodes for batteries, comprising, applying process products from step b) of claim 1 an electrically conductive substrate and subsequently dried.

9. (canceled)

10. Active material particles in the form of dispersible granules comprising:
silicon particles, ≥95% by weight, based on the dry weight of the active material particles in the form of dispersible granules,
one or more binder(s) selected from the group consisting of polyacrylic acid or salts thereof, polyvinyl alcohols, cellulose or cellulose derivatives, polyalkylene oxides, polyvinylidene fluoride, polytetrafluoroethylene, polyolefms, polyimides and ethylene-propylene-diene terpolymers and
optionally one or more additives.

11. The active material particles in the form of dispersible granules as claimed in claim 10, wherein the dispersible granules have a particle shape having sharp or round edges with approximately equal extensions in the three dimensions (method of determination: DIN ISO 3435).

12. The active material particles in the form of dispersible granules as claimed in claim 10, wherein no graphite is present.

13. The active material particles in the form of dispersible granules as claimed in claim 10, wherein the active material particles in the form of dispersible granules are not coated with carbon.

14. The method for processing electrode materials for batteries as claimed in claim 1, wherein the active material particles in the form of dispersible granules obtained in step a) are not subjected to any reaction, in particular pyrolysis or carbonization, before carrying out step b).
